(19) United States
(12) Patent Application Publication
(10) Pub. No.: US 2023/0306058 A1
(43) Pub. Date: Sep. 28, 2023

(54) PREDICTION DEVICE, PREDICTION METHOD, AND RECORDING MEDIUM

(71) Applicant: NEC Corporation, Minato-ku, Tokyo (JP)

(72) Inventors: Yoshijiro Matsubara, Tokyo (JP); Shingo Tanaka, Tokyo (JP); Toshihiko Haraki, Tokyo (JP); Yutong Zhang, Tokyo (JP)

(73) Assignee: NEC Corporation, Minato-ku, Tokyo (JP)

(21) Appl. No.: 18/022,060

(22) PCT Filed: Sep. 28, 2020
(86) PCT No.: PCT/JP2020/036568

§ 371 Date: Feb. 17, 2023

(51) Int. Cl. G06F 16/901; G06Q 10/04

(52) U.S. Cl. CPC G06F 16/9024; G06Q 10/04

(57) ABSTRACT

In a prediction device, an acquisition means acquires input data. A prediction means performs prediction based on elements included in the input data using a prediction model and generates a prediction result. A display control means generates a first display screen indicating the prediction result, based on the input data and the prediction result. Here, the first display screen includes a graph showing the prediction result generated for each unit time period over a predetermined time period, and a value of each element of the input data acquired for each unit time period. Also, the first display screen displays the value of each element of the input data in such a manner that an element used for the prediction and an element not used for the prediction are distinguished from each other.

### TECHNICAL FIELD

The present invention relates to prediction based on time series data.

### BACKGROUND ART

There are known prediction systems that output predicted values based on past numerical data. For example, Patent Document 1 discloses a system for predicting a future shipment amount of goods, using past shipment amount data and weather data. In this prediction system, prediction result data are displayed in a graph form, and shipment amount data and weather data used for prediction are displayed in a table form.

### PRECEDING TECHNICAL REFERENCES

### Patent Document

Patent Document 1: Japanese Patent Application Laid-Open under No. 2019-215831

### SUMMARY

### Problem to be Solved by the Invention

In the system of the Patent Document 1, the data used for the prediction is displayed in a table format. However, the data that is inputted to the prediction system but is not actually used for the prediction is not displayed. In addition, although the data used for the prediction is displayed, it is not known how they were actually used to calculate the predicted value.

It is an object of the present invention to provide a prediction device that presents prediction results such that a user can easily understand which of the data inputted for prediction are utilized and how they are utilized to obtain the prediction results.

### Means for Solving the Problem

According to an example aspect of the present invention, there is provided a prediction device comprising:

an acquisition means configured to acquire input data;

a prediction means configured to perform prediction based on elements included in the input data using a prediction model and generate a prediction result; and

a display control means configured to generate a first display screen indicating the prediction result, based on the input data and the prediction result,

wherein the first display screen includes a graph showing the prediction result generated for each unit time period over a predetermined time period, and a value of each element of the input data acquired for each unit time period, and

wherein the first display screen displays the value of each element of the input data in such a manner that an element used for the prediction and an element not used for the prediction are distinguished from each other.

According to another example aspect of the present invention, there is provided a prediction method comprising:

acquiring input data;

performing prediction based on elements included in the input data using a prediction model and generate a prediction result; and

generating a first display screen indicating the prediction result, based on the input data and the prediction result,

wherein the first display screen includes a graph showing the prediction result generated for each unit time period over a predetermined time period, and a value of each element of the input data acquired for each unit time period, and

wherein the first display screen displays the value of each element of the input data in such a manner that an element used for the prediction and an element not used for the prediction are distinguished from each other.

According to still another example aspect of the present invention, there is provided a recording medium recording a program, the program causing a computer to execute processing of:

acquiring input data;

performing prediction based on elements included in the input data using a prediction model and generate a prediction result; and

generating a first display screen indicating the prediction result, based on the input data and the prediction result,

wherein the first display screen includes a graph showing the prediction result generated for each unit time period over a predetermined time period, and a value of each element of the input data acquired for each unit time period, and

wherein the first display screen displays the value of each element of the input data in such a manner that an element used for the prediction and an element not used for the prediction are distinguished from each other.

### BRIEF DESCRIPTION OF THE DRAWINGS

FIG. 1 shows a prediction device according to a first example embodiment.

FIG. 2 is a block diagram showing a hardware configuration of the prediction device according to the first example embodiment.

FIG. 3 is a block diagram showing a functional configuration of the prediction device according to the first example embodiment.

FIG. 4 is a flowchart of prediction processing according to the first example embodiment.

FIG. 5 is a flowchart of prediction formula determination processing.

FIG. 6 shows an example of a main screen of a prediction result display screen.

FIG. 7 shows an example of a graph screen.

FIG. 8 shows an example of a prediction process screen.

FIG. 9 shows an example of a breakdown screen.

FIG. 10 shows an example of a determination process screen.

FIG. 11 shows an example of a contribution screen.

FIG. 12 shows an example of a determination process illustration screen.

FIG. 13 shows an example of a prediction formula list screen.

FIG. 14 shows an example of a configuration of a prediction system.

FIG. 15 is a block diagram showing a functional configuration of a prediction device according to a second example embodiment.

FIG. 16 is a flowchart of prediction processing of the second example embodiment.

### EXAMPLE EMBODIMENTS

Preferred example embodiments of the present invention will be described with reference to the accompanying drawings.

### FIRST EXAMPLE EMBODIMENT

[Prediction device]

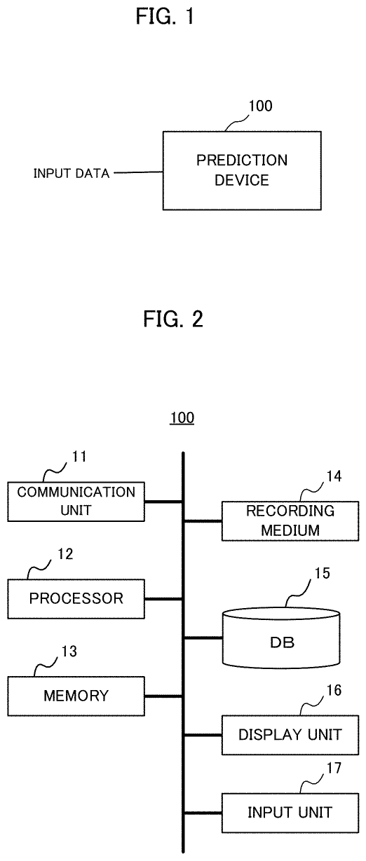

FIG. 1 shows a prediction device according to the first example embodiment. The prediction device 100 predicts demand and supply based on the input data of the time series, and displays the prediction result on the display unit or the like. For example, the prediction device 100 uses weather information for the prediction target day, calendar, commodity prices and the like as the input data, and predicts the number of sales of a particular product and the number of customers visited the store as the prediction of demand and supply. In the following example embodiments, it is assumed that the prediction device 100 predicts the number of visitors to the store, based on the weather, air temperature, humidity, and the like of the prediction target day.

[Hardware Configuration]

FIG. 2 is a block diagram illustrating a hardware configuration of the prediction device 100. As illustrated, the prediction device 100 includes a communication unit 11, a processor 12, a memory 13, a recording medium 14, a data base (DB) 15, a display unit 16, and an input unit 17.

The communication unit 11 inputs and outputs data to and from an external device. Specifically, when the input data used for prediction is inputted by communication from the outside, the communication unit 11 receives the input data. Also, the communication unit 11 is used to output the prediction result by the prediction device 100 to an external device.

The processor 12 is a computer such as a CPU (Central Processing Unit) and controls the entire prediction device 100 by executing a program prepared in advance. The processor 12 may be a GPU (Graphics Processing Unit) or a FPGA (Field-Programmable Gate Array). Specifically, the processor 12 executes the prediction processing described later.

The memory 13 may include a ROM (Read Only Memory) and a RAM (Random Access Memory). The memory 13 is also used as a working memory during various processing operations by the processor 12.

The recording medium 14 is a non-volatile and non-transitory recording medium such as a disk-like recording medium, a semiconductor memory, or the like, and is configured to be detachable from the prediction device 100. The recording medium 14 records various programs executed by the processor 12. When the prediction device 100 executes the prediction processing, the program recorded in the recording medium 14 is loaded into the memory 13 and executed by the processor 12.

The DB 15 stores the input data inputted through the communication unit 11 and the input data inputted via the input unit 17. Also, the DB 15 stores the daily prediction results generated by the prediction device 100.

The display unit 16 is, for example, a liquid crystal display device, and displays the prediction result generated by the prediction device 100. The input unit 17 is used by the user to input the input data used as the basis for the prediction. The input unit 17 is an example of an acquisition means and a designation means.

[Functional Configuration]

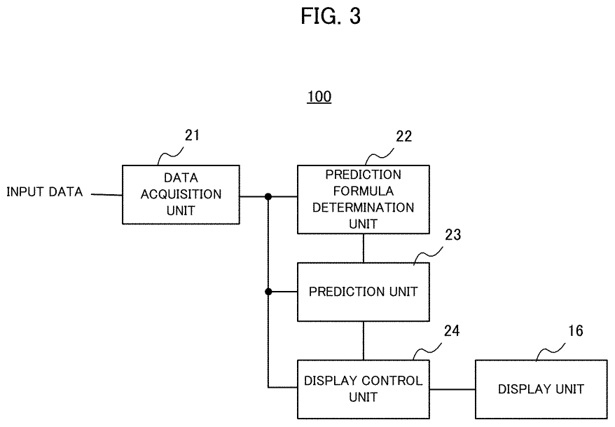

FIG. 3 is a block diagram showing the functional configuration of the prediction device 100. The prediction device 100 includes a data acquisition unit 21, a prediction formula determination unit 22, a prediction unit 23, and a display control unit 24 in terms of functions. The data acquisition unit 21 is implemented by the communication unit 11 or the input unit 17. The prediction formula determination unit 22, the prediction unit 23, and the display control unit 24 are implemented by the above-described processor 12.

The data acquisition unit 21 acquires the input data that is used as a basis of the prediction. The input data is data affecting the demand and supply. In the present example embodiment, the input data is weather information, calendar information, and the like that affect the number of visitors to the store. The data acquisition unit 21 outputs the acquired input data to the prediction formula determination unit 22, the prediction unit 23 and the display control unit 24. The data acquisition unit 21 is an example of an acquisition means.

The prediction formula determination unit 22 determines a prediction formula to be used for prediction, based on the input data. In the present example embodiment, a plurality of prediction formulas are prepared for the conditions defined by the value of each element of the input data (hereinafter, simply referred to as “condition of the input data”), and the prediction formula determination unit 22 determines an appropriate prediction formula based on the condition of the input data. For example, it is assumed that “weather” and “maximum temperature” are inputted to the prediction device 100 as the elements of the input data. In addition, it is assumed that the value of the element “weather” is one of “fine”, “cloudy”, “rainy” and “snowy”, and the value of the element “maximum temperature” is the maximum temperature. In this case, a plurality of prediction formulas corresponding to the conditions defined by the values of the weather and the maximum temperature, i.e., the combinations of the value of the weather and the value of the maximum temperature, are prepared in advance. Then, the prediction formula determination unit 22 determines the prediction formula corresponding to the combination of the weather and the maximum temperature of the prediction target day to be the optimum prediction formula. A specific example of a method for determining a prediction formula will be described later.

The prediction unit 23 predicts the number of visitors based on the input data, using the prediction formula determined by the prediction formula determination unit 22. Then, the prediction unit 23 outputs the calculated number of visitors to the display control unit 24 as a prediction result. The prediction unit 23 is an example of a prediction means.

The display control unit 24 executes processing for displaying the prediction result on the display unit 16. Specifically, the display control unit 24 acquires the input data from the data acquisition unit 21 and acquires the prediction result from the prediction unit 23. Then, the display control unit 24 generates a prediction result display screen including the input data and the prediction result, and displays it on the display unit 16. Since the prediction result display screen is a screen that displays both the input data that serves as the basis for prediction and the prediction results obtained based on it, the user can view the prediction result together with the reasons for the prediction result. Specific examples of the prediction result display screen will be described later. The display control unit 24 is an example of a display control means.

[Prediction Processing]

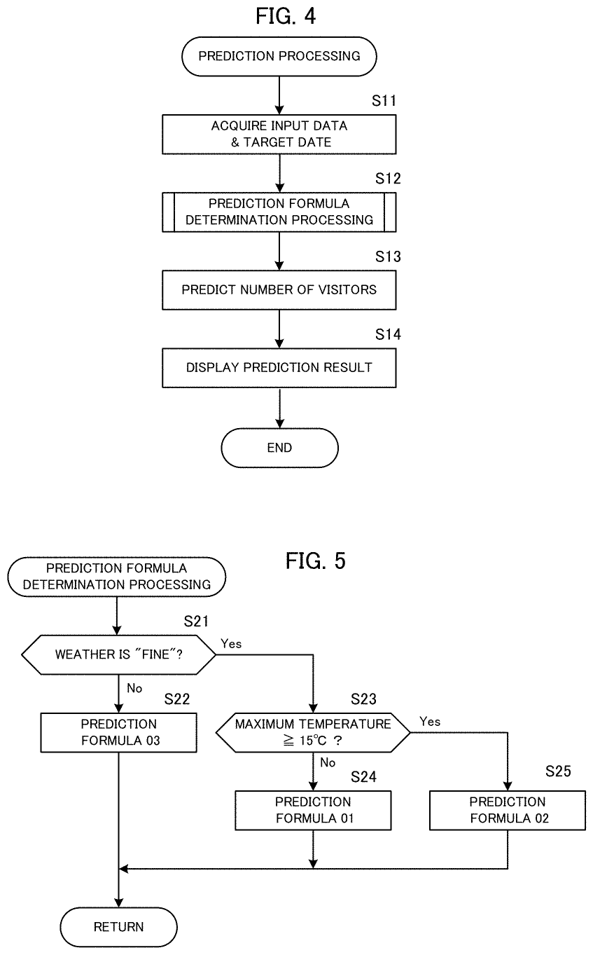

Next, the prediction processing will be described. FIG. 4 is a flowchart of the prediction processing. This processing is realized by the processor 12 shown in FIG. 2, which executes a program prepared in advance and operates as each element shown in FIG. 3.

First, the data acquisition unit 21 acquires the input data and the target date through the communication unit 11 or the input unit 17 (step S11). The “target date” is the date subjected to the prediction and is designated by the user. Next, the prediction formula determination unit 22 executes prediction formula determination processing for determining the prediction formula based on the input data and the target date (step S12).

FIG. 5 is a flowchart of the prediction formula determination processing. In this example, three prediction formulas 01-03 are provided depending on the weather and the maximum temperature included in the input data. First, the prediction formula determination unit 22 determines whether or not the weather included in the input data corresponding to the target date is “fine” (step S21). If the weather is not “fine” (step S21: No), the prediction formula determination unit 22 determines to use the prediction formula 03 (step S22), and the processing returns to the main routine shown in FIG. 4.

On the other hand, if the weather is “fine” (step S21: Yes), the prediction formula determination unit 22 determines whether or not the maximum temperature included in the input data is equal to or higher than 15° C. (step S23). If the maximum temperature is lower than 15° C. (step S23: No), the prediction formula determination unit 22 determines to use the prediction formula 01 (step S24), and the processing returns to the main routine shown in FIG. 4. On the other hand, if the maximum temperature is equal to or higher than 15° C. (step S23: Yes), the prediction formula determination unit 22 determines to use the prediction formula 02 (step S25), and the processing returns to the main routine shown in FIG. 4. Thus, in the prediction formula determination processing, the optimum prediction formula is determined from a plurality of prediction formulas prepared in advance on the basis of the condition defined by the values of the elements included in the input data.

Returning to FIG. 4, the prediction unit 23 predicts the number of visitors from the input data using the prediction formula determined by the prediction formula determination unit 22, and outputs the predicted value (the predicted number of visitors) to the display control unit 24 (step S13). Then, the display control unit 24 generates a prediction result display screen on the basis of the predicted value inputted from the prediction unit 23 and displays the prediction result display screen on the display unit 16 (step S14). Then, the prediction processing ends. When the target date is changed by the user, the prediction processing is executed again for the new target date.

[Prediction Result Display Screen]

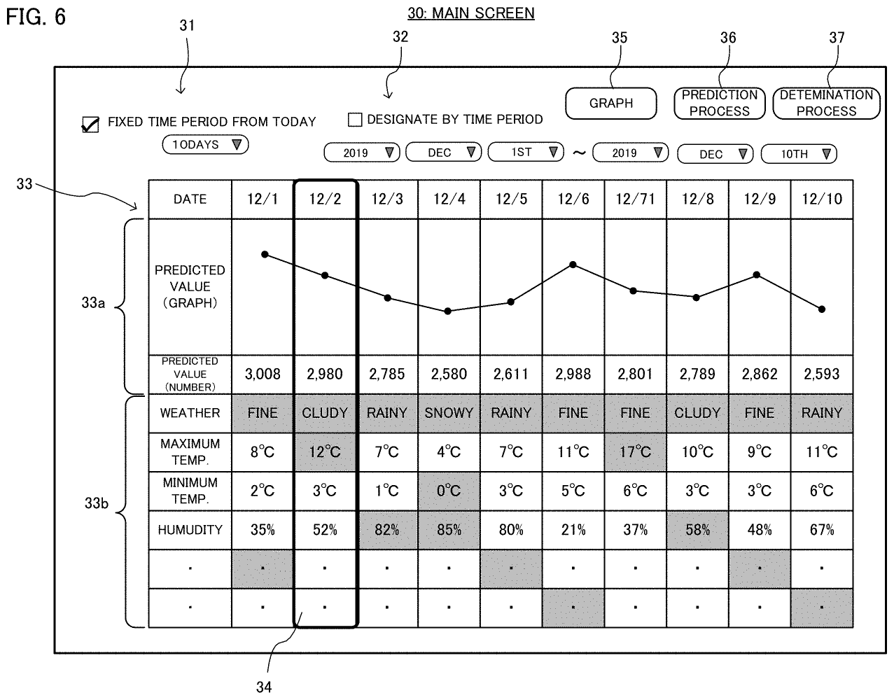

Next, a specific example of the prediction result display screen will be described. It is noted that the prediction result display screen includes a plurality of screens generated in a hierarchical structure. FIG. 6 shows an example of the main screen 30 of the prediction result display screen. The main screen 30 is an example of a first display screen and includes time period designation areas 31 and 32, a prediction result area 33, a cursor 34, a graph button 35, a prediction process button 36, and a determination process button 37.

The time period designation areas 31 and 32 are areas for designating a time period to be displayed as the prediction result. The time period designation area 31 is used to designate a fixed time period starting from the current day, and the user can designate a fixed time period by the pull-down menu. In the example of FIG. 6, “10 days” is selected in the pull-down menu and the prediction result of 10 days from 12/1 is displayed. The time period designation area 32 is used to designate the start date and the end date individually, and the user can designate the start date and the end date by the pull-down menu.

The prediction result area 33 is an area for displaying the prediction result of the number of visitors during the time period designated in the time period designation area 31 or 32. As illustrated, the prediction result area 33 includes, for each day in the designated time period, a prediction value section 33a indicating the predicted value of the number of visitors for that day, and an input data section 33b indicating the input data inputted for that day. The prediction value section 33a includes a line graph indicating the predicted value of the number of visitors during the designated time period and the numerical values of the daily predicted value. By showing the line graph in addition to the numerical values of the predicted values, a user can easily grasp the transition and tendency of the predicted value during the designated time period.

The input data section 33b shows the values of the elements of the input data for each day. In the example of FIG. 6, the input data includes such elements as the weather, the maximum temperature, the minimum temperature, the humidity, etc. Further, in the input data section 33b, the field of the value which is actually used in the prediction is displayed in gray. For example, for the day “12/3”, the fields of the value “rainy” of the element “weather” and the value “82%” of the element “humidity” are gray. This allows the user to know that the predicted value of the day 12/3 was calculated using the weather (rainy) and the humidity (82%) of the input data. In the above example, the background color of the field of the value used in the actual prediction is displayed in gray. However, this is merely an example, the values used for the prediction and the values not used for the prediction may be displayed in a manner distinguishable from each other by other methods. For example, the values used for the prediction and the values not used for the prediction may be distinguished by changing the color of the characters, changing the background color of the display field, or highlighting the characters.

The cursor 34 is used for selecting the day of interest from among the time period displayed in the prediction result area 33 and can be moved by the user's operation. In the example of FIG. 6, the user operated the input unit 17 to put the cursor 34 to the day 12/2. For the date designated by the cursor 34 (hereinafter, also referred to as “designated date”), more detailed information can be viewed as described later.

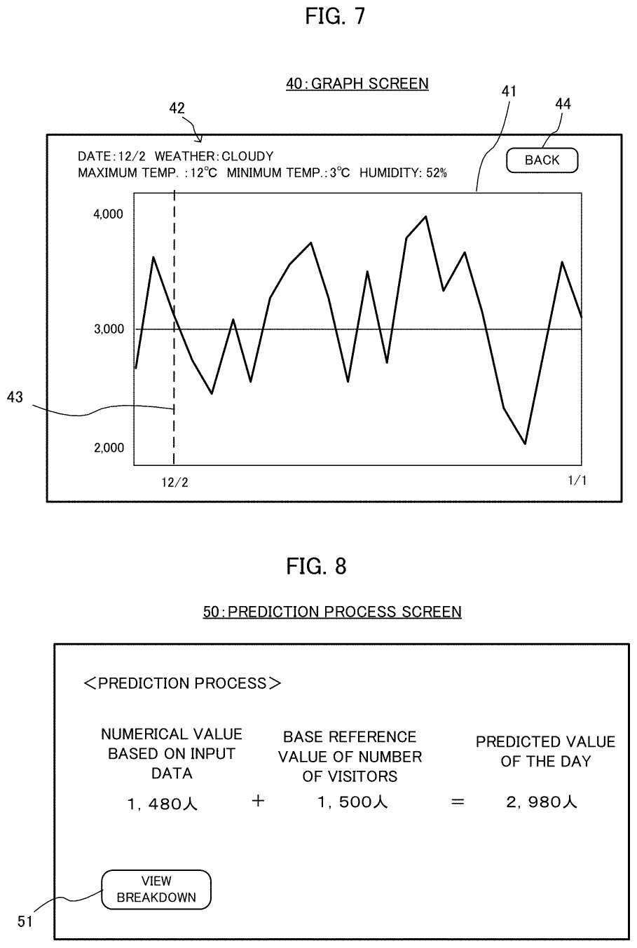

The graph button 35 is a button for displaying a graph of the predicted values. When the user presses the graph button 35, the graph screen 40 illustrated in FIG. 7 is displayed instead of the main screen 30 shown in FIG. 6. The graph screen 40 includes a graph 41, designated date information 42, a designated date line 43, and a back button 44. The graph 41 shows the predicted value of the number of visitors. The graph 41 is basically the same as the values shown in the predicted value section 33a of FIG. 6. However, the graph of the predicted value section 33a is a simple graph, whereas the graph 41 of the graph screen 40 displays details of the graph in an easy-to-see manner, for example, the predicted value of the number of visitors is shown on the vertical axis. In the example of FIG. 7, the time period indicated by the graph 41 is in coincidence with the time period designated in the time period designation area 31 or 32 shown in FIG. 6. However, the graph screen of FIG. 7 may also be provided with the same area as the time period designation area 31, 32 of FIG. 6, and the time period displayed on the graph screen 40 may be set individually. By providing the graph screen 40, the user can grasp the transition of daily predicted values in more detail.

The designated date information 42 is the input data of the designated date designated by the cursor 34 in the main screen 30 of FIG. 6. In the example of FIG. 7, the weather, the maximum temperature, the minimum temperature, and the humidity are displayed. Further, the designated day line 43 indicates the position of the designated day in the graph 41. The designated date indicated by the designated date line 43 may be changed in accordance with the cursor 34 in FIG. 6, or may be changed by the user's operation on the graph screen 40.

The back button 44 is a button for returning from the graph screen 40 to the main screen 30. In the above-described example, when the user presses the graph button 35 on the main screen, the graph screen 40 is displayed instead of the main screen 30. Instead, the graph screen 40 may be displayed on the main screen as a separate window. In this case, instead of the back button 44, a close button for closing the window may be provided.

Returning to FIG. 6, when the user presses the prediction process button 36 on the main screen 30, the prediction process screen is displayed. FIG. 8 is an example of the prediction process screen 50. The prediction process screen 50 may be displayed in place of the main screen 30, or may be displayed as a window separate from the main screen 30.

The prediction process screen 50 is an example of the second display screen and displays an explanation of the process when the prediction device 100 predicts the predicted value. The prediction process screen 50 displays the prediction process for the designated day designated by the cursor 34 of FIG. 6. The prediction process displayed here is based on the prediction formula used to predict the number of visitors that day. In the example of FIG. 8, the predicted value is calculated using the above-described prediction formula 01, and it is now assumed that the prediction formula 01 is as follows, for example.

Prediction formula01:P=a₁x+b₁y+c

Here, “a₁” is a coefficient when the weather is fine, “x” is the value of the weather, “b₁” is a coefficient when the maximum temperature is lower than 15° C., “y” is the value of the maximum temperature, and “c” is a constant.

In this case, “the numerical value based on the input data” in FIG. 8 is a numerical value calculated based on the weather and the maximum temperature, and is a value corresponding to the term “a₁x+b₁y” of the prediction formula 01. On the other hand, “the base reference value of the number of visitors” is a value corresponding to the constant “c” of the prediction formula 01. By looking at this prediction process screen 50, the user can understand that the standard number of visitors is about 1500 people, and the predicted value is calculated by adding the variation based on the weather and the air temperature, which are input data, to the standard number of visitors.

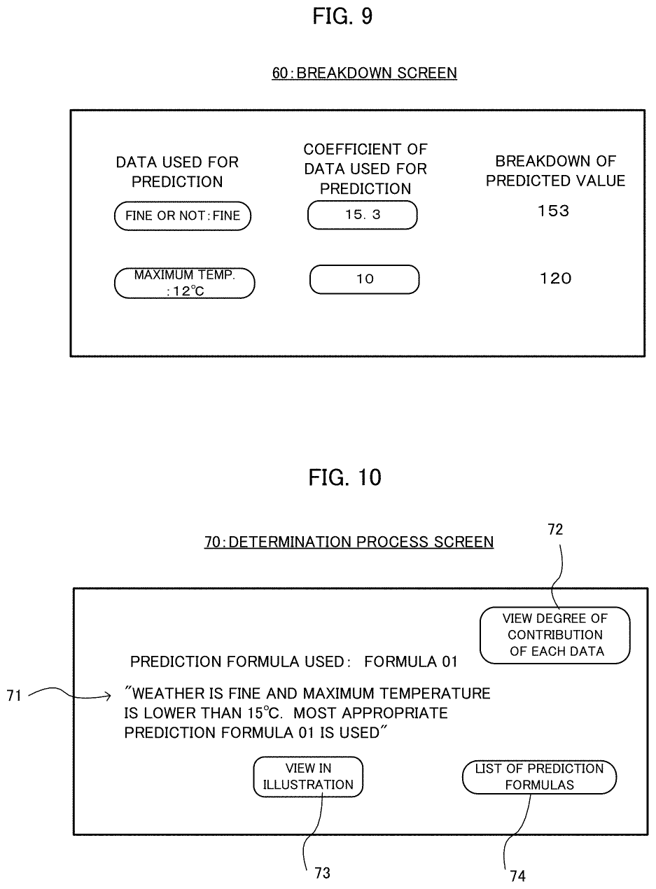

Further, when the user presses the button 51 of “View Breakdown” on the prediction process screen 50, the breakdown screen is displayed. FIG. 9 shows an example of the breakdown screen 60. The breakdown screen 60 may be displayed in place of the prediction process screen 50, or may be displayed as a window separate from the prediction process screen 50.

The breakdown screen 60 is an example of a third display screen, and explains the breakdown of “the numerical value based on the input data” shown in the prediction process screen 50. In the example of FIG. 9, the breakdown screen 60 shows that the weather “fine” and the maximum temperature “12° C.” in the input data were used for the prediction. Also, the coefficient used in calculation for the weather “fine”, i.e., the degree to which the weather “fine” is reflected in the predicted value, is indicated as “15.3”. Also, the coefficient used in calculation for the maximum temperature “12° C.”, i.e., the degree to which the maximum temperature “12° C.” is reflected in the predicted value, is indicated as “10”. It is noted that the coefficient “15.3” for the weather “fine” corresponds to the coefficient “a₁” of the prediction formula 01, and the coefficient “10” for the maximum temperature “12° C.” corresponds to the coefficient “b₁” of the prediction formula 01. In addition, “Breakdown of predicted values” on the breakdown screen 60 indicates a value in which each input data is reflected in the predicted value. For example, it is shown that “153” people in the predicted value are calculated based on the weather “fine”, and “120” people in the predicted value are calculated based on the maximum temperature “12° C.”. Thus, by displaying the breakdown screen 60, the user can know which one of the input data is reflected in the prediction and how much the data is reflected in the prediction.

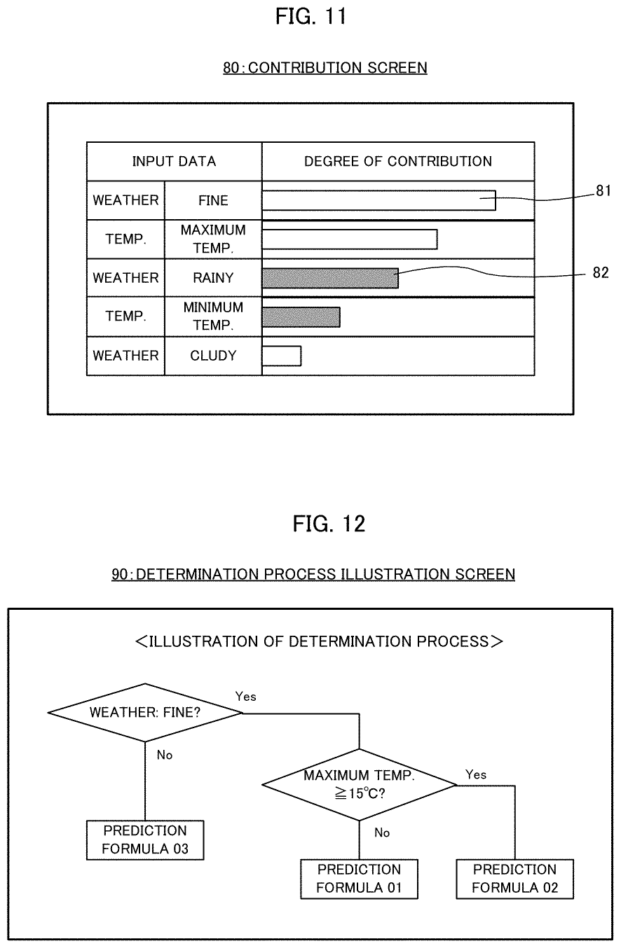

While the degree of contribution of the individual input data are displayed from the top in the order from a large absolute value to a small absolute value in the example of FIG. 9, the degree of contribution may be displayed collectively for each category of the input data. For example, in the example of each input data in FIG. 11, the degree of contribution of the category “weather (fine, cloudy, rain)” is displayed in order from the top, and then the degree of contribution of the category “air temperature (maximum temperature, minimum temperature)” may be displayed in order. In this case, the order in each category may be arranged from the top in the order from a large absolute value to a small absolute value. In that case, in the example of FIG. 11, “fine”, “rainy” and “cloudy” are displayed in this order from the top in the category “weather”, and “maximum temperature” and “minimum temperature” are displayed in this order from the top in the category “air temperature”.

Returning to FIG. 6, when the user presses the determination process button 37, the determination process screen is displayed. FIG. 10 is an example of the determination process screen. The determination process screen 70 may be displayed instead of the main screen 30, or may be displayed in as a window separate from the main screen 30. The determination process screen 70 is a screen for explaining a process of determination performed when generating a prediction result. Specifically, the determination process screen 70 indicates which of the input data was used to determine the prediction formula to perform prediction.

The determination process screen 70 is an example of a fourth display screen and includes an explanation 71 of the determination process, a button 72 for viewing the degree of contribution of each input data, a button 73 for viewing the determination process in the illustration, and a button 74 for viewing a list of prediction formulas.

The explanation 71 includes a description of the prediction formula used for the prediction. In the example of FIG. 10, it is described that the prediction formula 01 was used. The explanation 71 also includes a description of why the prediction formula was used. In the example of FIG. 10, it is described that the prediction formula 01 was selected on the basis of the condition that the weather of the input data is fine and the maximum temperature is lower than 15° C. By reading the explanation 71, the user can easily understand in what determination process the prediction formula was determined and used.

When the user presses the button 72 in the determination process screen 70, the contribution screen is displayed. FIG. 11 is an example of the contribution screen 80. The contribution screen 80 may be displayed instead of the determination process screen 70, or may be displayed in a window separate from the determination process screen 70.

The contribution screen 80 is an example of a sixth display screen, and shows the degree of contribution of the input data in the prediction as the bar graph, for each value of each element of the input data. In the example of FIG. 11, the respective degrees of contribution of the weather “fine”, the maximum temperature, the weather “rainy”, the minimum temperature, and the weather “cloudy” are shown as the elements of the input data. The white bar graph 81 shows the positive contribution, i.e., the contribution in the direction of increasing the predicted number of visitors. On the other hand, the gray graph 82 shows the negative contribution, i.e., the contribution in the direction of decreasing the predicted number of visitors. For example, the input data of the weather “fine” acts to increase the predicted value of the number of visitors, and the input data of the weather “rainy” acts to decrease the predicted value of the number of visitors. In the contribution degree screen 80, the degree of contribution of each input data is displayed in descending order of the absolute value from the top. By looking at the contribution screen 80, the user can know which input data is acting on the predicted value and how the input data is acting on the predicted value, i.e., whether the individual input data is increasing or decreasing the predicted value.

In the determination process screen 70 shown in FIG. 10, when the user presses the button 73 for viewing the determination process in an illustration, the determination process illustration screen is displayed. FIG. 12 shows an example of the determination process illustration screen 90. The determination process illustration screen 90 is an example of a fifth display screen, and shows a method of determining the prediction formula based on the input data. In the example of FIG. 12, a determination process is shown in which the prediction formula is determined based on the condition of the value of each element included in the input data by using a decision tree. This determination process is consistent with the content of the explanation 71 in FIG. 10. That is, the explanation 71 is a text illustrating the process of determining the prediction formula based on the determination process. The content of the determination process shown in the example of FIG. 12 is the same as the prediction formula determination processing shown in FIG. 5. By looking at the determination process illustration screen 90, the user can know in what process the prediction formula was determined based on the input data.

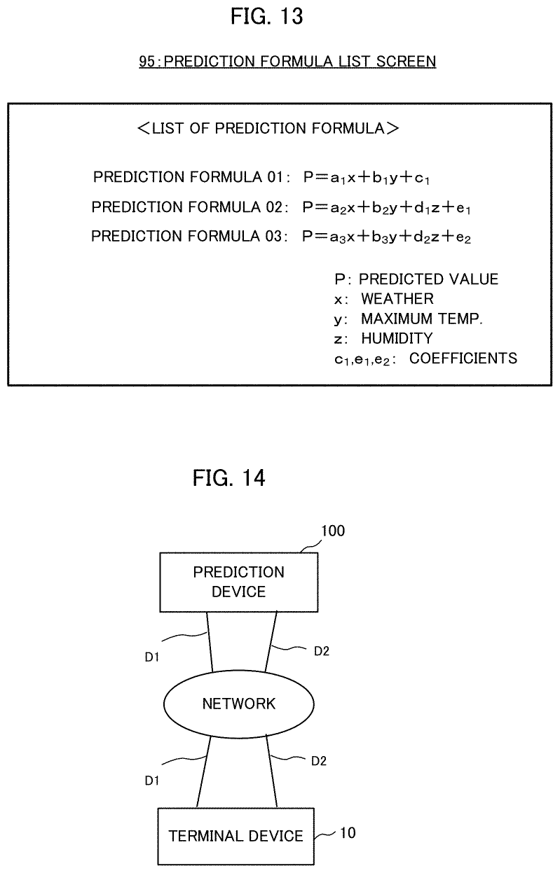

In FIG. 10, when the user presses the prediction formula list button 74, a prediction formula list screen is displayed. FIG. 13 shows an example of the prediction formula list screen 95. The prediction formula list screen 95 may be displayed instead of the determination process screen 70, or may be displayed as a window separate from the determination process screen 70. The prediction formula list screen 95 is an example of the seventh display screen, and shows the contents of a plurality of prediction formulas used in the determination process. This allows the user to know how the predicted values are calculated using each prediction formula.

[Modification]

For the first example embodiment described above, it is possible to apply the following modifications. The following modifications can be applied in combination as required.

(Modification 1)

In the above-described first example embodiment, the prediction device 100 is a single terminal device. Instead, the prediction device 100 may be configured as a server device, and a prediction system may be configured by the combination of the server device and a terminal device. FIG. 14 shows an example of the configuration of the prediction system. The prediction system includes the prediction device 100 and a terminal device 10. The prediction device 100 is configured as a server device and communicates with the terminal device 10 via a network. The terminal device 10 is a PC, tablet, or the like used by the user.

The user operates the terminal device 10 to input and transmit the input data D1 to the prediction device 100. The prediction device 100 performs prediction by using the input data D1, generates a prediction result display screen D2 based on the prediction result and transmits it to the terminal device 10. The prediction result display screen is the respective display screens shown in FIGS. 6 to 13. The terminal device 10 receives and displays the predicted result display screen D2. Thus, the user can view the display screen shown in FIGS. 6 to 13 on the terminal device 10.

(Modification 2)

In the above-described example embodiment, the prediction device 100 predicts the number of visitors using the prediction formula. However, the method of prediction by the prediction device 100 is not limited this method. For example, a plurality of prediction models may be prepared, and prediction may be performed by selecting an optimum prediction model according to the conditions of the input data. Each prediction model may be a model that performs prediction using machine learning, a neural network, or the like. Further, although the above example embodiment predicts the number of visitors in the store, the method of the present example embodiment can be applied to the prediction of other various types of demand and supply, i.e., demand and supply of various time-series data, such as power demand and supply, and the number of shipments of products from manufacturers and factories.

### Second Example Embodiment

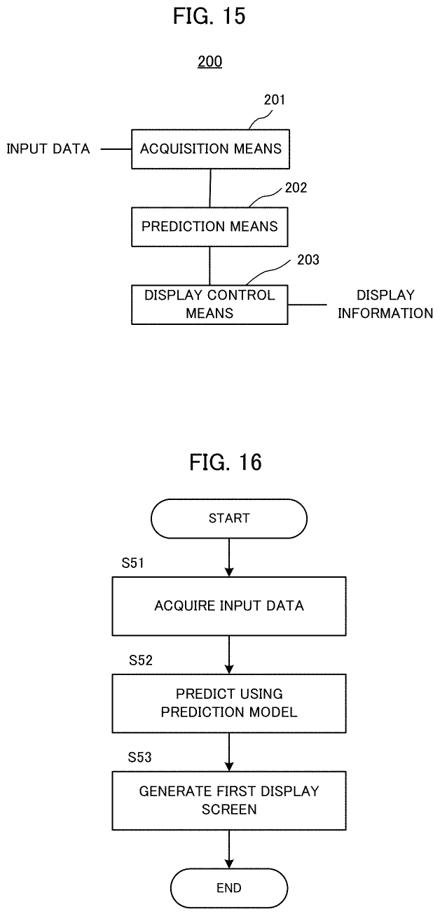

Next, a second example embodiment of the present invention will be described. FIG. 15 is a block diagram illustrating a functional configuration of a prediction device 200 according to the second example embodiment. The prediction device 200 includes an acquisition means 201, a prediction means 202, and a display control means 203. The acquisition means 201 acquires input data. The prediction means performs prediction based on elements included in the input data using a prediction model and generates a prediction result. The display control means generates a first display screen indicating the prediction result, based on the input data and the prediction result. Here, the first display screen includes a graph showing the prediction result generated for each unit time period over a predetermined time period, and a value of each element of the input data acquired for each unit time period. Also, the first display screen displays the value of each element of the input data in such a manner that an element used for the prediction and an element not used for the prediction are distinguished from each other.

FIG. 16 is a flowchart of prediction processing performed by the prediction device 200 according to the second example embodiment. First, the acquisition means 201 acquires input data (step S51). Next, the prediction means performs prediction based on elements included in the input data using a prediction model and generates a prediction result (step S52). Then, the display control means generates a first display screen indicating the prediction result, based on the input data and the prediction result (step S53). Here, the first display screen includes a graph showing the prediction result generated for each unit time period over a predetermined time period, and a value of each element of the input data acquired for each unit time period. Also, the first display screen displays the value of each element of the input data in such a manner that an element used for the prediction and an element not used for the prediction are distinguished from each other.

According to the second example embodiment, since the elements used for the prediction and the elements not used are displayed distinguishably in the display screen of the prediction result, the user can easily know which element of the input data was used for the prediction.

A part or all of the example embodiments described above may also be described as the following supplementary notes, but not limited thereto.

(Supplementary Note 1)

A prediction device comprising:

an acquisition means configured to acquire input data;

a prediction means configured to perform prediction based on elements included in the input data using a prediction model and generate a prediction result; and

a display control means configured to generate a first display screen indicating the prediction result, based on the input data and the prediction result,

wherein the first display screen includes a graph showing the prediction result generated for each unit time period over a predetermined time period, and a value of each element of the input data acquired for each unit time period, and

wherein the first display screen displays the value of each element of the input data in such a manner that an element used for the prediction and an element not used for the prediction are distinguished from each other.

(Supplementary Note 2)

The prediction device according to Supplementary note 1, wherein the display control means displays the element used for the prediction in a highlighted manner in the first display screen.

(Supplementary Note 3)

The prediction device according to Supplementary note 1 or 2, further comprising a designation means configured to receive a designation of a unit time period in the predetermined time period,

wherein the display control means generates a second display screen which displays information on a prediction process that generated the prediction result for the designated unit time period.

(Supplementary Note 4)

The prediction device according to Supplementary note 3, wherein the display control means generates a fourth display screen which displays the value of the element of the input data used for the prediction and a coefficient value for the element.

(Supplementary Note 5)

The prediction device according to Supplementary note 3 or 4,

wherein the prediction model includes a plurality of prediction formulas selected based on a condition that the value of each element of the input data satisfies, and

wherein the display control means generates a fourth display screen including description of the condition used to select, from the plurality of prediction formulas, the prediction formula which is used to generate the prediction result for the designated unit time period.

(Supplementary Note 6)

The prediction device according to Supplementary note 5, wherein the display control means generates a fifth display screen illustratively showing the condition used to select, from the plurality of prediction formulas, the prediction formula which is used to generate the prediction result for the designated unit time period.

(Supplementary Note 7)

The prediction device according to any one of Supplementary notes 3 to 6, wherein the display control means generates a sixth display screen indicating a contribution degree to the prediction result of each element of the input data included in the prediction formula, which is used to generate the prediction result for the designated unit time period.

(Supplementary Note 8)

The prediction device according to any one of Supplementary notes 5 to 7, wherein the display control means generates a seventh display screen showing a list of the plurality of prediction formulas.

(Supplementary Note 9)

The prediction device according to any one of Supplementary notes 1 to 8, wherein the display control means displays the display screen on a display unit.

(Supplementary Note 10)

The prediction device according to any one of Supplementary notes 1 to 8, further comprising a transmitting means configured to transmit the display screen to a terminal device.

(Supplementary Note 11)

A prediction method comprising:

acquiring input data;

performing prediction based on elements included in the input data using a prediction model and generate a prediction result; and

generating a first display screen indicating the prediction result, based on the input data and the prediction result,

wherein the first display screen includes a graph showing the prediction result generated for each unit time period over a predetermined time period, and a value of each element of the input data acquired for each unit time period, and

wherein the first display screen displays the value of each element of the input data in such a manner that an element used for the prediction and an element not used for the prediction are distinguished from each other.

(Supplementary Note 12)

A recording medium recording a program, the program causing a computer to execute processing of:

acquiring input data;

performing prediction based on elements included in the input data using a prediction model and generate a prediction result; and

generating a first display screen indicating the prediction result, based on the input data and the prediction result,

wherein the first display screen includes a graph showing the prediction result generated for each unit time period over a predetermined time period, and a value of each element of the input data acquired for each unit time period, and

wherein the first display screen displays the value of each element of the input data in such a manner that an element used for the prediction and an element not used for the prediction are distinguished from each other.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

10 Terminal device
12 Processor
16 Display unit
21 Data acquisition unit
22 Prediction formula determination unit
23 Prediction unit
24 Display control unit
100 Prediction device

What is claimed is:

1. A prediction device comprising:
a memory configured to store instructions; and
one or more processors configured to execute the instructions to:
acquire input data;
perform prediction based on elements included in the input data using a prediction model and generate a prediction result; and
generate a first display screen indicating the prediction result, based on the input data and the prediction result,
wherein the first display screen includes a graph showing the prediction result generated for each unit time period over a predetermined time period, and a value of each element of the input data acquired for each unit time period, and
wherein the first display screen displays the value of each element of the input data in such a manner that an element used for the prediction and an element not used for the prediction are distinguished from each other.

2. The prediction device according to claim 1, wherein the one or more processors display the element used for the prediction in a highlighted manner in the first display screen.

3. The prediction device according to claim 1,
wherein the one or more processors are further configured to receive a designation of a unit time period in the predetermined time period,
wherein the one or more processors generate a second display screen which displays information on a prediction process that generated the prediction result for the designated unit time period.

4. The prediction device according to claim 3, wherein the one or more processors generate a third display screen which displays the value of the element of the input data used for the prediction and a coefficient value for the element.

5. The prediction device according to claim 3,
wherein the prediction model includes a plurality of prediction formulas selected based on a condition that the value of each element of the input data satisfies, and
wherein the one or more processors generate a fourth display screen including description of the condition used to select, from the plurality of prediction formulas, the prediction formula which is used to generate the prediction result for the designated unit time period.

6. The prediction device according to claim 5, wherein the one or more processors generate a fifth display screen illustratively showing the condition used to select, from the plurality of prediction formulas, the prediction formula which is used to generate the prediction result for the designated unit time period.

7. The prediction device according to claim 3, wherein the one or more processors generate a sixth display screen indicating a contribution degree to the prediction result of each element of the input data included in the prediction formula, which is used to generate the prediction result for the designated unit time period.

8. The prediction device according to claim 5, wherein the one or more processors generate a seventh display screen showing a list of the plurality of prediction formulas.

9. The prediction device according to claim 1, wherein the one or more processors display the display screen on a display unit.

10. The prediction device according to claim 1, wherein the one or more processors are further configured to transmit the display screen to a terminal device.

11. A prediction method comprising:
acquiring input data;
performing prediction based on elements included in the input data using a prediction model and generate a prediction result; and
generating a first display screen indicating the prediction result, based on the input data and the prediction result,
wherein the first display screen includes a graph showing the prediction result generated for each unit time period over a predetermined time period, and a value of each element of the input data acquired for each unit time period, and
wherein the first display screen displays the value of each element of the input data in such a manner that an element used for the prediction and an element not used for the prediction are distinguished from each other.

12. A non-transitory computer-readable recording medium recording a program, the program causing a computer to execute processing of:
acquiring input data;
performing prediction based on elements included in the input data using a prediction model and generate a prediction result; and
generating a first display screen indicating the prediction result, based on the input data and the prediction result,
wherein the first display screen includes a graph showing the prediction result generated for each unit time period over a predetermined time period, and a value of each element of the input data acquired for each unit time period, and
wherein the first display screen displays the value of each element of the input data in such a manner that an element used for the prediction and an element not used for the prediction are distinguished from each other.
